(19) United States
(12) Patent Application Publication
(10) Pub. No.: US 2024/0063459 A1
(43) Pub. Date: Feb. 22, 2024

(54) BATTERY CELL AND BATTERY MODULE INCLUDING THE SAME

(71) Applicant: SK ON CO., LTD., Seoul (KR)

(72) Inventors: Kyung Hee JEONG, Daejeon (KR); Tae Il KIM, Daejeon (KR)

(21) Appl. No.: 18/448,974

(22) Filed: Aug. 14, 2023

(30) Foreign Application Priority Data
Aug. 22, 2022 (KR) 10-2022-0104947

(51) Int. Cl. H01M 10/647; H01M 50/105; H01M 50/148; H01M 10/613; H01M 10/654; H01M 50/211; H01M 50/24

(52) U.S. Cl. CPC H01M 10/647; H01M 50/105; H01M 50/148; H01M 10/613; H01M 10/654; H01M 50/211; H01M 50/24

(57) ABSTRACT

A battery cell and a battery module including the same are disclosed. The battery cell includes a cell body including an electrode assembly and a pouch sheet wrapping the electrode assembly, the cell body extending from a lower end and leading to an upper end, the pouch sheet overlapping and contacting each other at the upper end; a pouch cover formed of the pouch sheet, the pouch cover extending from the upper end of the cell body and facing a lateral face of the cell body; and a heat transfer unit disposed between the cell body and the pouch cover.

### CROSS-REFERENCE TO RELATED APPLICATIONS

This application claims the priority benefit of Korean Patent Application No. 10-2022-0104947 filed on Aug. 22, 2022, which is incorporated herein by reference for all purposes as if fully set forth herein.

### TECHNICAL FIELD

The present disclosure relates to a battery cell and a battery module including the same. More particularly, the present disclosure relates to a battery cell with improved cooling performance and a battery module including the same.

### BACKGROUND

Since overheating of battery cells may lead to fire and thermal runaway, it is necessary to maintain a temperature of the battery cells below a certain level. That is, there is a need to effectively cool the battery cells.

A pouch type secondary battery cell is configured such that a pouch wraps and seals an electrode assembly. The pouch type secondary battery cell generally has a structure in which a cooling plate contacts one edge of the secondary battery cell to discharge heat.

However, since the edge of the secondary battery cell has a limited area, a method of cooling a lateral face of the secondary battery cell may be considered in order to effectively cool the secondary battery cell.
(Patent Document 1) U.S. Ser. No. 11/183,717 B2

### SUMMARY

An object of the present disclosure is to address the above-described and other problems.

Another object of the present disclosure is to provide a battery cell effectively removing heat generated on a lateral face of the battery cell and a battery module including the battery cell.

Another object of the present disclosure is to provide a battery cell effectively removing heat generated on both lateral faces of the battery cell and a battery module including the battery cell.

Another object of the present disclosure is to provide a battery cell including a pouch cover extending from a pouch sheet wrapping an electrode assembly and facing a lateral face of the battery cell and a heat transfer unit contacting the lateral face of the battery cell, and a battery module including the battery cell.

In order to achieve the above-described and other objects and needs, in one aspect of the present disclosure, there is provided a battery cell comprising a cell body including an electrode assembly and a pouch sheet wrapping the electrode assembly, the cell body extending from a lower end and leading to an upper end, the pouch sheet being overlapped and contacted at the upper end; a pouch cover formed of the pouch sheet, the pouch cover extending from the upper end of the cell body and facing a lateral face of the cell body; and a heat transfer unit disposed between the cell body and the pouch cover.

In another aspect of the present disclosure, there is provided a battery module comprising a battery cell assembly including a plurality of battery cells stacked forward and backward; and a bottom plate positioned below the battery cell assembly and contacting the battery cell assembly, wherein each of the plurality of battery cells includes a cell body including an electrode assembly and a pouch sheet wrapping the electrode assembly, the cell body extending from a lower end and leading to an upper end, the pouch sheet being overlapped and contacted at the upper end; a pouch cover formed of the pouch sheet, the pouch cover extending from the upper end of the cell body and facing a lateral face of the cell body; and a heat transfer unit disposed between the cell body and the pouch cover.

Effects of the battery module according to the present disclosure are described as follows.

According to at least one aspect of the present disclosure, the present disclosure can provide a battery cell effectively removing heat generated on the lateral face of the battery cell and a battery module including the battery cell.

According to at least one aspect of the present disclosure, the present disclosure can provide a battery cell effectively removing heat generated on both lateral faces of the battery cell and a battery module including the battery cell.

According to at least one aspect of the present disclosure, the present disclosure can provide a battery cell including a pouch cover extending from a pouch sheet wrapping an electrode assembly and facing a lateral face of the battery cell and a heat transfer unit contacting the lateral face of the battery cell, and a battery module including the battery cell.

Additional scope of applicability of the present disclosure will become apparent from the detailed description given blow. However, it should be understood that the detailed description and specific examples such as embodiments of the present disclosure are given merely by way of example, since various changes and modifications within the spirit and scope of the present disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIG. 1 illustrates a battery module according to an embodiment of the present disclosure.

FIG. 2 is an exploded perspective view of a battery module illustrated in FIG. 1.

FIG. 3 illustrates a battery cell assembly according to an embodiment of the present disclosure.

FIG. 4 illustrates a pouch sheet according to an embodiment of the present disclosure.

FIG. 5 illustrates a cross section of a pouch sheet taken along A-A of FIG. 4.

FIG. 6 illustrates one battery cell in a cross section of a battery cell illustrated in FIG. 2 taken along B-B of FIG. 2.

FIG. 7 illustrates that a pouch cover of FIG. 6 includes a first pouch cover.

FIG. 8 illustrates that a pouch cover of FIG. 7 includes a second pouch cover.

FIG. 9 illustrates that a pouch cover of FIG. 8 includes a third pouch cover.

FIG. 10 illustrates that a pouch cover of FIG. 9 includes a fourth pouch cover.

FIG. 11 illustrates that a pouch cover wing of FIG. 6 is bifurcated from a pouch cover base.

FIG. 12 illustrates that a pouch reinforcement part is coupled to a pouch cover wing of FIG. 11.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In general, a suffix such as “module” and “unit” may be used to refer to elements or components. Use of such a suffix herein is merely intended to facilitate description of the present disclosure, and the suffix itself is not intended to give any special meaning or function. It will be noted that a detailed description of known arts will be omitted if it is determined that the detailed description of the known arts can obscure the embodiments of the disclosure. The accompanying drawings are used to help easily understand various technical features and it should be understood that embodiments presented herein are not limited by the accompanying drawings. As such, the present disclosure should be construed to extend to any alterations, equivalents and substitutes in addition to those which are particularly set out in the accompanying drawings.

The terms including an ordinal number such as first, second, etc. may be used to describe various components, but the components are not limited by such terms. The terms are used only for the purpose of distinguishing one component from other components.

When any component is described as “being connected” or “being coupled” to other component, this should be understood to mean that another component may exist between them, although any component may be directly connected or coupled to the other component. In contrast, when any component is described as “being directly connected” or “being directly coupled” to other component, this should be understood to mean that no component exists between them.

A singular expression can include a plural expression as long as it does not have an apparently different meaning in context.

In the present disclosure, terms “include” and “have” should be understood to be intended to designate that illustrated features, numbers, steps, operations, components, parts or combinations thereof are present and not to preclude the existence of one or more different features, numbers, steps, operations, components, parts or combinations thereof, or the possibility of the addition thereof.

In the drawings, sizes of the components may be exaggerated or reduced for convenience of explanation. For example, the size and the thickness of each component illustrated in the drawings are arbitrarily illustrated for convenience of explanation, and thus the present disclosure is not limited thereto unless specified as such.

If any embodiment is implementable differently, a specific order of processes may be performed differently from the order described. For example, two consecutively described processes may be performed substantially at the same time, or performed in the order opposite to the described order.

In the following embodiments, when layers, areas, components, etc. are connected, the following embodiments include both the case where layers, areas, and components are directly connected, and the case where layers, areas, and components are indirectly connected to other layers, areas, and components intervening between them. For example, when layers, areas, components, etc. are electrically connected, the present disclosure includes both the case where layers, areas, and components are directly electrically connected, and the case where layers, areas, and components are indirectly electrically connected to other layers, areas, and components intervening between them.

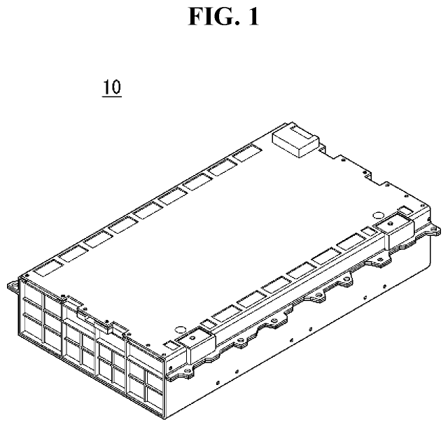

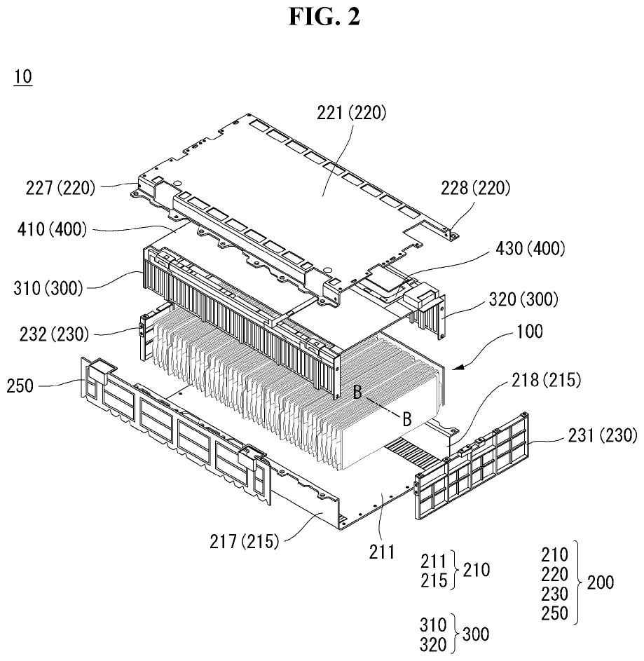

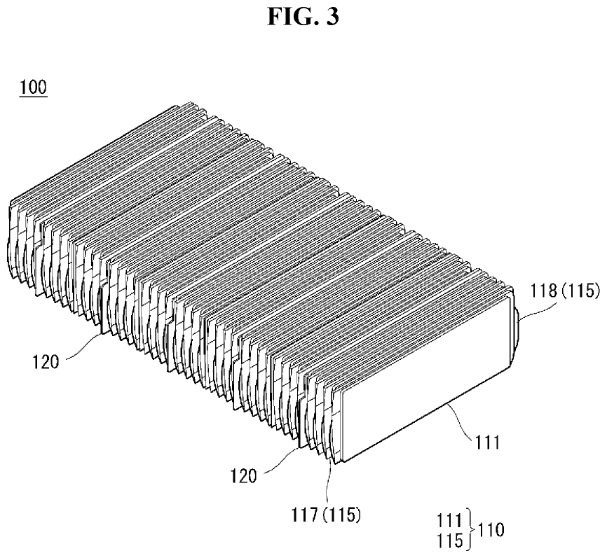

FIG. 1 illustrates a battery module 10 according to an embodiment of the present disclosure. FIG. 2 is an exploded perspective view of the battery module 10 illustrated in FIG. 1. FIG. 3 illustrates a battery cell assembly 100 according to an embodiment of the present disclosure. In the present disclosure, an up-down direction and a front-rear direction may be defined based on FIG. 2.

Referring to FIGS. 1 to 3, the battery module 10 may include the battery cell assembly 100. The battery cell assembly 100 may include a plurality of battery cells 110. The plurality of battery cells 110 may be arranged or stacked in one direction. For example, the direction in which the plurality of battery cells 110 are arranged or stacked may be a longitudinal direction or length direction of the battery module 10. The longitudinal direction of the battery module may be a front-rear direction of the battery module 10.

Each of the plurality of battery cells 110 may include a battery cell body 111. The battery cell body 111 may extend from one end and lead to other end. The one end of the battery cell body 111 may be referred to as a “first end” of the battery cell body 111. The other end of the battery cell body 111 may be referred to as a “second end” of the battery cell body 111.

For example, the battery cell body 111 may form a shape extending in a width direction or a transverse direction of the battery module 10. In other words, the longitudinal direction or length direction of the battery cell body 111 may be the width direction or the transverse direction of the battery module 10.

Each of the plurality of battery cells 110 may include an electrode lead tab 115. The electrode lead tab 115 may form a shape extending from the battery cell body 111. For example, the electrode lead tab 115 may form a shape protruding from the battery cell body 111. For example, the electrode lead tab 115 may include a first electrode lead tab 117 protruding from the first end of the battery cell body 111. For example, the electrode lead tab 115 may include a second electrode lead tab 118 protruding from the second end of the battery cell body 111.

The battery cell assembly 100 may include a heat blocking pad 120. The heat blocking pad 120 may be disposed between the plurality of battery cells 110. When thermal runaway occurs in one battery cell 110 of the plurality of battery cells 110, the heat blocking pad 120 can suppress heat or flame from the battery cell 110, in which the thermal runaway occurs, from moving to the neighboring battery cells 110. The heat blocking pad 120 may include a heat resistant material.

The battery module 10 may include a case assembly 200. The case assembly 200 may be referred to as a “battery case”. The case assembly 200 may include a first case 210. The first case 210 may accommodate the battery cell assembly 100.

The first case 210 may include a bottom case 211. The bottom case 211 may form the bottom of the case assembly 200. The bottom case 211 may be positioned below the battery cell assembly 100. In other words, the battery cell assembly 100 may be loaded into the bottom case 211. The bottom case 211 may form a plate shape. The bottom case 211 may be referred to as a “bottom plate”.

The bottom plate 211 may include four edges. The four edges of the bottom plate 211 may form a perimeter of the bottom plate 211. Two connection edges of the bottom plate 211 may be two edges extending along the longitudinal direction or the transverse direction of the battery module 10 among the four edges of the bottom plate 211.

A “first connection edge” of the bottom plate 211 may be a connection edge adjacent to the first end of the battery cell body 111 among the two connection edges of the bottom plate 211. A “second connection edge” of the bottom plate 211 may be a connection edge adjacent to the second end of the battery cell body 111 among the two connection edges of the bottom plate 211. The first connection edge and the second connection edge of the bottom plate 211 may face each other or be parallel to each other.

The first case 210 may include a side case 215. The side case 215 may be formed to extend upward from the bottom plate 211. The side case 215 may be integrally formed with the bottom plate 211.

A plurality of side cases 215 may be provided. For example, the side cases 215 may include a first side case 217 extending upward from the first connection edge of the bottom plate 211. For example, the side cases 215 may include a second side case 218 extending upward from the second connection edge of the bottom plate 211. The second side case 218 may face the first side case 217. A direction from the first side case 217 to the second side case 218 may be parallel to the transverse direction of the battery module 10.

The case assembly 200 may include a second case 220. The second case 220 may include a top case 221. The top case 221 may be formed of a material including metal. The top case 221 may be referred to as a “top cover”.

The top case 221 may include four edges. The four edges of the top case 221 may form a perimeter of the top case 221. Two connection edges of the top case 221 may be two edges extending along the longitudinal direction or the transverse direction of the battery module 10 among the four edges of the top case 221.

A “first connection edge” of the top case 221 may be a connection edge adjacent to the first end of the battery cell body 111 among the two connection edges of the top case 221. A “second connection edge” of the top case 221 may be a connection edge adjacent to the second end of the battery cell body 111 among the two connection edges of the top case 221. The first connection edge and the second connection edge of the top case 221 may face each other or be parallel to each other.

The second case 220 may include wing cases 227 and 228. The wing cases 227 and 228 may be integrally formed with the top case 221. The wing cases 227 and 228 may extend downward from the edge of the top case 221.

For example, the wing cases 227 and 228 may include a first wing case 227 extending downward from the first connection edge of the top case 221. For example, the wing cases 227 and 228 may include a second wing case 228 extending downward from the second connection edge of the top case 221.

The wing cases 227 and 228 may be coupled or fastened to the side case 215. For example, the first wing case 227 may be coupled or fastened to the first side case 217. For example, the second wing case 228 may be coupled or fastened to the second side case 218.

The case assembly 200 may include a front-rear case 230. The front-rear case 230 may include a front case 231. The front case 231 may face the battery cell assembly 100. The front case 231 may be positioned in front of the battery cell assembly 100.

The front case 231 may be connected or coupled to a front end of the first side case 217. The front case 231 may be connected or coupled to a front end of the second side case 218. The front case 231 may be connected or coupled to a front end of the bottom case 211. The front case 231 may be referred to as a “first cover plate”.

The front-rear case 230 may include a rear case 232. The rear case 232 may face the battery cell assembly 100. The rear case 232 may be positioned behind the battery cell assembly 100.

The rear case 232 may be connected or coupled to a rear end of the first side case 217. The rear case 232 may be connected or coupled to a rear end of the second side case 218. The rear case 232 may be connected or coupled to a rear end of the bottom case 211. The rear case 232 may be referred to as a “second cover plate”.

The front-rear case 230 may be referred to as a “cover plate”. The cover plate 230 may indicate at least one of a first cover plate 231 and a second cover plate 232.

The case assembly 200 may include an insulating cover 250. The insulating cover 250 may be disposed between the battery cell assembly 100 and the side case 215. The insulating cover 250 may include an insulating material.

The battery module 10 may include a bus bar unit 300. The bus bar unit 300 may be electrically connected to the battery cell assembly 100. The bus bar unit 300 may be disposed between the battery cell assembly 100 and the case assembly 200. The bus bar unit 300 may electrically connect the plurality of battery cells 110. A plurality of bus bar units 300 may be provided.

For example, the bus bar unit 300 may include a first bus bar unit 310 disposed between the first side case 217 and the battery cell assembly 100. The first bus bar unit 310 may electrically connect the first electrode lead tabs 117 of the plurality of battery cells 110.

For example, the bus bar unit 300 may include a second bus bar unit 320 disposed between the second side case 218 and the battery cell assembly 100. The second bus bar unit 320 may electrically connect the second electrode lead tabs 118 of the plurality of battery cells 110.

The battery module 10 may include a battery sensing unit 400. The battery sensing unit 400 may include a sensing frame 410. The sensing frame 410 may connect the first bus bar unit 310 and the second bus bar unit 320. The sensing frame 410 may be positioned between the battery cell assembly 100 and the top case 221. The sensing frame 410 may form a plate or board shape.

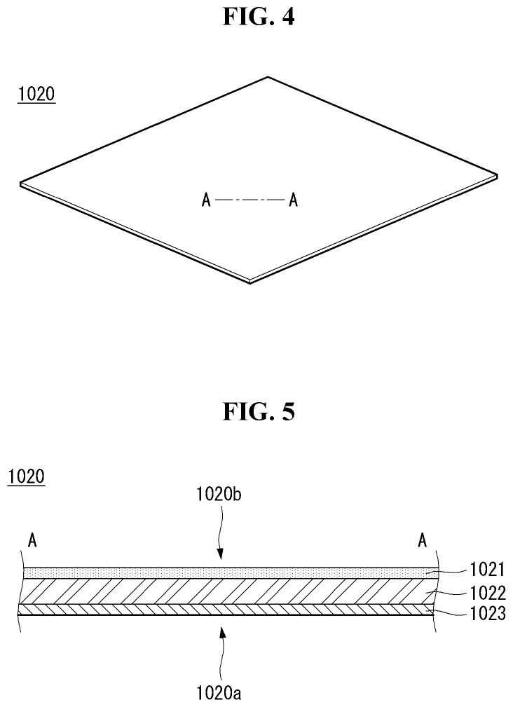

FIG. 4 illustrates a pouch sheet according to an embodiment of the present disclosure. FIG. 5 illustrates a cross section of a pouch sheet taken along A-A of FIG. 4.

Referring to FIGS. 4 and 5, the battery cell 110 (see FIG. 3) according to an embodiment of the present disclosure may include a pouch sheet 1020. For example, the battery cell body 111 (see FIG. 3) may include an electrode assembly and the pouch sheet 1020 wrapping the electrode assembly.

The pouch sheet 1020 may have a sheet shape. The pouch sheet 1020 may have flexibility. That is, the pouch sheet 1020 may be bent or folded. The pouch sheets 1020 may overlap and contact each other.

The pouch sheet 1020 may form both surfaces. For example, one surface of the pouch sheet 1020 may be a pouch sheet outer surface 1020a. The pouch sheet outer surface 1020a may form an outer surface of the battery cell 110 (see FIG. 3).

For example, other surface of the pouch sheet 1020 may be a pouch sheet inner surface 1020b. The pouch sheet inner surface 1020b may form an inner surface of the battery cell 110 (see FIG. 3). For example, the pouch sheet inner surface 1020b may face or contact the electrode assembly.

The pouch sheet 1020 may include a plurality of layers. For example, the pouch sheet 1020 may include a first pouch sheet layer 1021. The first pouch sheet layer 1021 may form the pouch sheet inner surface 1020b.

The first pouch sheet layer 1021 may be formed by overlapping and coupling a plurality of layers with each other. For example, the first pouch sheet layer 1021 may include a plurality of layers coupled to each other by heat. For example, the first pouch sheet layer 1021 may be formed of a material including a polymer.

The pouch sheet 1020 may include a second pouch sheet layer 1022. The second pouch sheet layer 1022 may contact the first pouch sheet layer 1021. For example, one surface of the second pouch sheet layer 1022 may contact the opposite surface of the pouch sheet inner surface 1020b among both surfaces of the first pouch sheet layer 1021.

In other words, one surface of the first pouch sheet layer 1021 may form the pouch sheet inner surface 1020b, and other surface of the first pouch sheet layer 1021 may contact and be coupled to the second pouch sheet layer 1022.

The second pouch sheet layer 1022 may be formed of a material including metal. The second pouch sheet layer 1022 may be formed of a material including, for example, aluminum. For example, the second pouch sheet layer 1022 may be a metal thin film.

The pouch sheet 1020 may include a third pouch sheet layer 1023. The third pouch sheet layer 1023 may contact the other surface of the second pouch sheet layer 1022. The first to third pouch sheet layers 1021, 1022, and 1023 may be sequentially formed. In other words, the second pouch sheet layer 1022 may be positioned between the first pouch sheet layer 1021 and the third pouch sheet layer 1023.

The third pouch sheet layer 1023 may form the pouch sheet outer surface 1020a. The third pouch sheet layer 1023 may provide a waterproof function. The third pouch sheet layer 1023 may be formed of a material including a polymer.

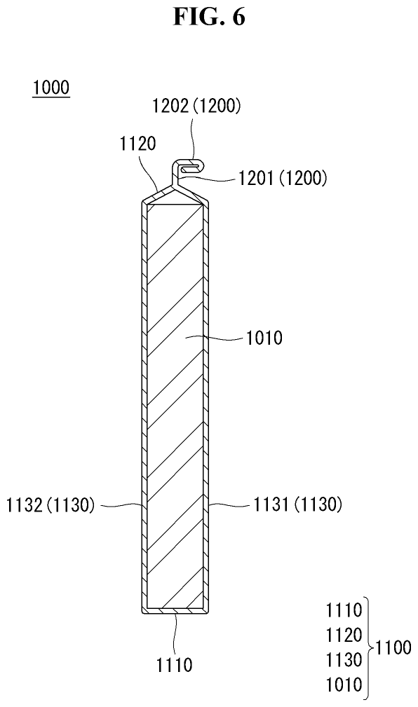

FIG. 6 illustrates one battery cell in a cross section of a battery cell illustrated in FIG. 2 taken along B-B of FIG. 2.

FIG. 6 may be a figure illustrating a cross section of the battery cell illustrated in FIG. 2 cut along the width direction of the battery cell. The battery cell illustrated in FIG. 6 may be the battery cell illustrated in FIG. 3. For example, FIG. 6 may be a cross section of the battery cell 110 illustrated in FIG. 2 cut along a direction perpendicular to the longitudinal direction of the battery cell body 111 (see FIG. 3).

Referring to FIG. 6, a battery cell 1000 may include a cell body 1100. The cell body 1100 may be the battery cell body 111 illustrated in FIG. 3. The cell body 1100 may include an electrode assembly 1010. The pouch sheet 1020 (see FIGS. 4 and 5) may cover the electrode assembly 1010.

The cell body 1100 may include a cell body lower surface 1110. The cell body lower surface 1110 may contact an upper surface of the bottom plate 211 (see FIG. 2). The cell body 1100 may provide heat to the bottom plate 211 (see FIG. 2) through the cell body lower surface 1110. In this context, the bottom plate 211 (see FIG. 2) may be referred to as a “cooling plate”.

The cell body lower surface 1110 may be a surface facing downward among outer surfaces of the cell body 1100. The cell body lower surface 1110 may be formed by the pouch sheet 1020 (see FIGS. 4 and 5).

The cell body 1100 may include a cell body upper surface 1120. The cell body upper surface 1120 may be a surface facing upward among the outer surfaces of the cell body 1100. The cell body upper surface 1120 may be formed by the pouch sheet 1020 (see FIGS. 4 and 5). The cell body upper surface 1120 may be positioned opposite the cell body lower surface 1110.

The cell body 1100 may include a cell body lateral face 1130. The cell body lateral face 1130 may be a lateral face of the cell body 1100. The cell body lateral face 1130 may be a surface facing the lateral face among the outer surfaces of the cell body 1100. The cell body lateral face 1130 may connect the cell body lower surface 1110 and the cell body upper surface 1120. For example, the cell body lateral face 1130 may extend from the cell body lower surface 1110 and lead to the cell body upper surface 1120.

A plurality of cell body lateral faces 1130 may be provided. For example, the cell body lateral faces 1130 may include a first cell body lateral face 1131 and a second cell body lateral face 1132. The first cell body lateral face 1131 and the second cell body lateral face 1132 may be positioned opposite each other.

The first cell body lateral face 1131 may extend from one end of the cell body lower surface 1110 and lead to one end of the cell body upper surface 1120. The second cell body lateral face 1132 may extend from other end of the cell body lower surface 1110 and lead to other end of the cell body upper surface 1120.

The cell body lateral face 1130 may face a direction in which the plurality of battery cells 110 (see FIGS. 2 and 3) are disposed. For example, the cell body lateral face 1130 may face the front-rear direction of the battery cell assembly 100 (see FIG. 2). For example, the cell body lateral face 1130 may face the front or the rear.

For example, the first cell body lateral face 1131 may face or be directed toward the front. In this context, the first cell body lateral face 1131 may be referred to as a “cell body front face”. For example, the second cell body lateral face 1132 may face or be directed toward the rear. In this context, the second cell body lateral face 1132 may be referred to as a “cell body rear face”.

The battery cell 1000 may include a pouch cover 1200. The pouch cover 1200 may be formed using the pouch sheet 1020 (see FIGS. 4 and 5). For example, the pouch cover 1200 may extend from the cell body upper surface 1120.

For example, the pouch cover 1200 may be formed to extend from the cell body upper surface 1120 in a state in which two pouch sheets 1020 (see FIGS. 4 and 5) are coupled to each other. The first pouch sheet layers 1021 (see FIG. 5) of the two pouch sheets 1020 (see FIGS. 4 and 5) may be coupled to each other by heat or/and pressure.

The pouch cover 1200 may include a pouch cover base 1201. The pouch cover base 1201 may extend from the cell body upper surface 1120. The pouch cover base 1201 may be formed by coupling the two pouch sheets 1020 (see FIGS. 4 and 5).

For example, the pouch cover base 1201 may be formed by coupling the first pouch sheet layers 1021 (see FIG. 5) of the two pouch sheets 1020 (see FIGS. 4 and 5) to each other.

For example, the pouch cover base 1201 may be formed by extending the pouch sheet 1020 (see FIGS. 4 and 5) from the cell body upper surface 1120.

For example, the first pouch sheet layers 1021 (see FIG. 5) of the two pouch sheets 1020 (see FIGS. 4 and 5) may face each other and be coupled to each other to form the pouch cover base 1201.

The pouch cover 1200 may include a pouch cover wing 1202. The pouch cover wing 1202 may extend from the pouch cover base 1201. For example, the pouch cover wing 1202 may be bent and extended from the pouch cover base 1201.

For example, the pouch cover wing 1202 may be bent and extended forward from an end of the pouch cover base 1201. For example, the pouch cover wing 1202 may be bent and extended in a direction, that the cell body lateral face 1130 faces, from the end of the pouch cover base 1201. For example, the pouch cover wing 1202 may be folded at one point.

For another example, the pouch cover wing 1202 may extend forward or backward from the cell body upper surface 1120. For example, the pouch cover wing 1202 may be formed to extend forward from the cell body upper surface 1120 in a state in which the two pouch sheets 1020 (see FIGS. 4 and 5) are coupled to each other.

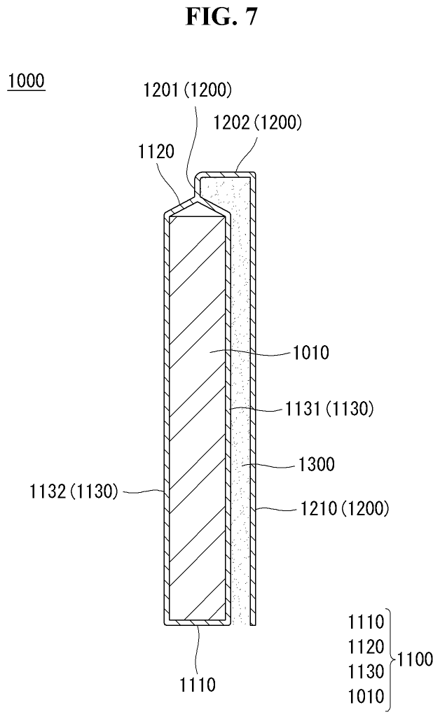

FIG. 7 illustrates that a pouch cover of FIG. 6 includes a first pouch cover.

Referring to FIG. 7, the pouch cover 1200 may include a first pouch cover 1210. The first pouch cover 1210 may extend from the pouch cover wing 1202.

For example, the first pouch cover 1210 may be bent and extended from an end of the pouch cover wing 1202 toward the cell body lower surface 1110. The first pouch cover 1210 may be referred to as a “first side pouch cover”. Alternatively, the first pouch cover 1210 may be referred to as a “front pouch cover”.

The first pouch cover 1210 may face the cell body lateral face 1130. For example, the first pouch cover 1210 may face the first cell body lateral face 1131. The first cell body lateral face 1131 may be a front face of the cell body 1100. That is, the first pouch cover 1210 may face the front face of the cell body 1100.

The first pouch cover 1210 may be spaced apart from the first cell body lateral face 1131. For example, a gap may be formed between the first pouch cover 1210 and the first cell body lateral face 1131.

The battery cell 1000 may include a heat transfer unit 1300. The heat transfer unit 1300 may have a relatively high heat transfer coefficient. For example, the heat transfer unit 1300 may be formed of a material including a heat conductive material. For example, the heat transfer unit 1300 may be formed of a material including nanocarbon. For example, the heat transfer unit 1300 may include a plurality of nanocarbon particles and a polymer.

The heat transfer unit 1300 may be disposed between the first pouch cover 1210 and the cell body 1100. For example, the heat transfer unit 1300 may be applied to an outer surface of the cell body 1100.

For example, after the heat transfer unit 1300 is applied to the outer surface of the cell body 1100, the first pouch cover 1210 may cover the heat transfer unit 1300. For example, the heat transfer unit 1300 may be applied to the first cell body lateral face 1131, and the first pouch cover 1210 may cover the heat transfer unit 1300 or may be coupled to the heat transfer unit 1300. The first pouch cover 1210 may form a front face of the battery cell 1000.

For example, the heat transfer unit 1300 may be positioned or applied to the cell body lateral face 1130. The heat transfer unit 1300 positioned on the cell body lateral face 1130 may lead to the cell body lower surface 1110. For example, a part of the heat transfer unit 1300 may be positioned on the cell body lateral face 1130, and another part of the heat transfer unit 1300 may be positioned on the cell body lower surface 1110.

For example, the heat transfer unit 1300 may contact the bottom plate 211 (see FIG. 2). For example, a part of the heat transfer unit 1300 may be positioned between the cell body lower surface 1110 and the bottom plate 211 (see FIG. 2).

The heat transfer unit 1300 may receive heat from the cell body 1100. For example, at least a portion of heat generated in the first cell body lateral face 1131 may be transferred to the bottom plate 211 (see FIG. 2) through the heat transfer unit 1300.

In other words, the heat transfer unit 1300 may be a heat sink of the cell body 1100. The heat transfer unit 1300 may transfer at least a portion of the heat received from the cell body 1100 to the bottom plate 211 (see FIG. 1). Hence, the heat transfer unit 1300 may cool the cell body 1100. That is, at least a part of the heat transfer unit 1300 may be a “cooling member” that cools the cell body 1100.

For another example, the heat transfer unit 1300 may transfer at least a portion of the heat received from the cell body 1100 to the pouch cover 1200. At least a portion of the heat transferred to the pouch cover 1200 may be discharged to the outside of the battery cell 1000 through radiation. For example, at least a portion of heat transferred to the pouch cover wing 1202 may be discharged to the outside of the battery cell 1000 through radiation.

The heat transfer unit 1300 may be formed of a material including a flame blocking material. In other words, the heat transfer unit 1300 may include a flame blocking member. For example, the flame blocking member of the heat transfer unit 1300 may be formed of a material including a high-density polymer. For example, the flame blocking member of the heat transfer unit 1300 may be formed of a material including at least one of an ethylene copolymer, aluminum hydroxide, or calcium carbonate.

The flame blocking member of the heat transfer unit 1300 can suppress a fire generated in the cell body 1100 from being transferred to neighboring battery cells. In other words, the flame blocking member of the heat transfer unit 1300 may serve as a thermal barrier.

The cooling member and the flame blocking member of the heat transfer unit 1300 may be stacked. For example, the cooling member and the flame blocking member may be stacked to form the heat transfer unit 1300. The cooling member of the heat transfer unit 1300 may include a heat conductive material.

For example, the cooling member of the heat transfer unit 1300 may be applied to or in contact with the outer surface of the cell body 1100, and the flame blocking member of the heat transfer unit 1300 may be applied to or in contact with the cooling member of the heat transfer unit 1300.

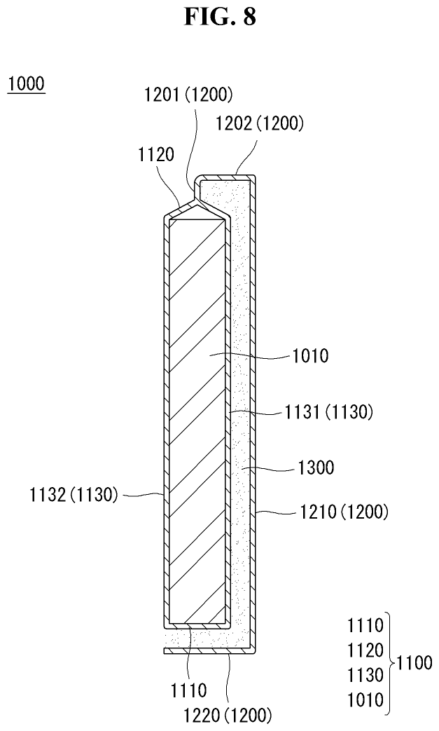

FIG. 8 illustrates that a pouch cover of FIG. 7 includes a second pouch cover.

Referring to FIG. 8, the pouch cover 1200 may include a second pouch cover 1220. The second pouch cover 1220 may extend from the first pouch cover 1210.

For example, the second pouch cover 1220 may be bent and extended from a lower end of the first pouch cover 1210. For example, the second pouch cover 1220 may extend rearward from the lower end of the first pouch cover 1210. The second pouch cover 1220 may be referred to as a “lower pouch cover”. The second pouch cover 1220 may form a lower surface of the battery cell 1000.

The second pouch cover 1220 may be positioned under the cell body lower surface 1110. The second pouch cover 1220 may be spaced apart from the cell body lower surface 1110. The heat transfer unit 1300 may be disposed between the second pouch cover 1220 and the cell body lower surface 1110.

For another example, the second pouch cover 1220 may contact the cell body lower surface 1110. At least a portion of heat transferred to the heat transfer unit 1300 may be transferred to the bottom plate 211 (see FIG. 2) through the second pouch cover 1220.

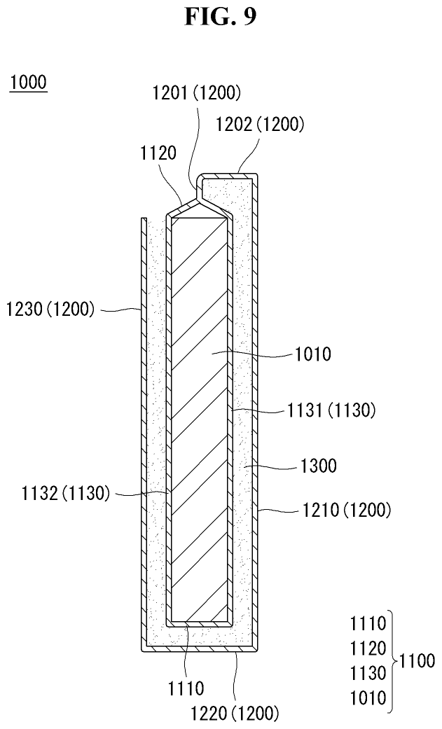

FIG. 9 illustrates that a pouch cover of FIG. 8 includes a third pouch cover.

Referring to FIG. 9, the pouch cover 1200 may include a third pouch cover 1230. The third pouch cover 1230 may extend from the second pouch cover 1220. The third pouch cover 1230 may form a shape extending upward from a rear end of the second pouch cover 1220.

The third pouch cover 1230 may be referred to as a “second side pouch cover”. The third pouch cover 1230 may be referred to as a “rear pouch cover”. The rear pouch cover 1230 may form a rear face of the battery cell 1000.

The side pouch covers 1210 and 1230 may indicate at least one of the first side pouch cover 1210 and the second side pouch cover 1230. The side pouch covers 1210 and 1230 may be referred to as “front and rear pouch covers”.

The third pouch cover 1230 may face the second cell body lateral face 1132. The third pouch cover 1230 may be spaced apart from the second cell body lateral face 1132. A gap may be formed between the third pouch cover 1230 and the second cell body lateral face 1132.

The heat transfer unit 1300 may be disposed between the third pouch cover 1230 and the second cell body lateral face 1132. The heat transfer unit 1300 may be applied to the second cell body lateral face 1132. For example, after the heat transfer unit 1300 is applied to the second cell body lateral face 1132, the third pouch cover 1230 may cover the heat transfer unit 1300.

For example, a front portion of the heat transfer unit 1300 may be disposed between the cell body 1100 and the front pouch cover 1210, and a lower portion of the heat transfer unit 1300 may be disposed between the cell body 1100 and the lower pouch cover 1220. Further, a rear portion of the heat transfer unit 1300 may be disposed between the cell body 1100 and the rear pouch cover 1230.

Heat generated in the second cell body lateral face 1132 may be transferred to the rear portion of the heat transfer unit 1300. For example, at least a portion of the heat generated in the second cell body lateral face 1132 may sequentially pass through the heat transfer unit 1300 and the second pouch cover 1220 and may be transferred to the bottom plate 211 (see FIG. 1).

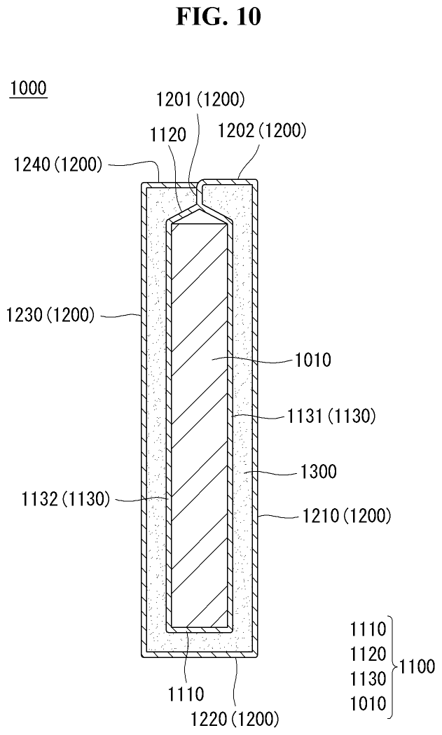

FIG. 10 illustrates that a pouch cover of FIG. 9 includes a fourth pouch cover.

Referring to FIG. 10, the pouch cover 1200 may include a fourth pouch cover 1240. The fourth pouch cover 1240 may be bent and extended from the third pouch cover 1230 toward the pouch cover wing 1202. The fourth pouch cover 1240 may be disposed on the cell body upper surface 1120.

The fourth pouch cover 1240 may be connected to the pouch cover base 1201. For example, the fourth pouch cover 1240 may be connected to an upper end of the pouch cover base 1201. The fourth pouch cover 1240 may be connected to the pouch cover wing 1202. For example, the fourth pouch cover 1240 may be connected to a rear end of the pouch cover wing 1202.

Referring to FIGS. 7 to 10, the pouch cover 1200 may be formed by extending from the pouch sheet 1020 (see FIGS. 4 and 5) forming the outer surface of the cell body 1100. In other words, the outer surface of the cell body 1100 and the pouch cover 1200 may be formed of one pouch sheet 1020 (see FIGS. 4 and 5).

The pouch cover 1200 may be formed by coupling the overlapped pouch sheets 1020 (see FIGS. 4 and 5) with each other. For example, the pouch cover base 1201 and the pouch cover wing 1202 may be formed by attaching the overlapped pouch sheets 1020 (see FIGS. 4 and 5) to each other. That is, the pouch cover base 1201 and the pouch cover wing 1202 may seal the pouch sheet 1020 (see FIGS. 4 and 5).

As the pouch sheets 1020 (see FIGS. 4 and 5) that are overlapped and coupled to each other lengthen, a degree of sealing of the pouch sheets 1020 (see FIGS. 4 and 5) may increase. For example, a degree of sealing of the pouch sheet 1020 (see FIGS. 4 and 5) when the pouch cover 1200 includes the first pouch cover 1210 may be greater than a degree of sealing of the pouch sheet 1020 (see FIGS. 4 and 5) when the pouch cover 1200 does not include the first pouch cover 1210.

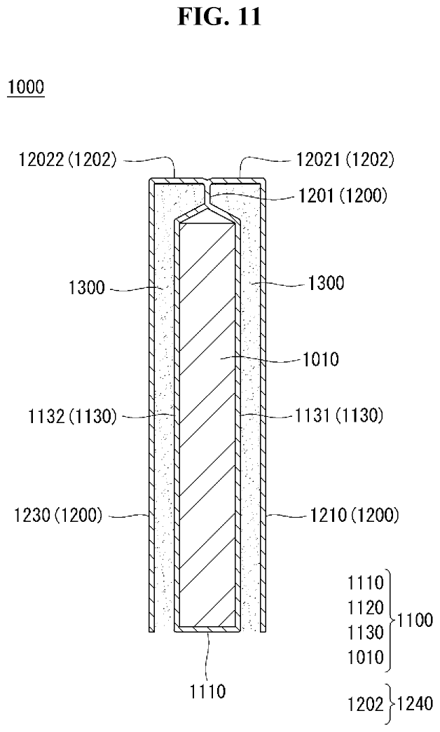

FIG. 11 illustrates that a pouch cover wing of FIG. 6 is bifurcated from a pouch cover base.

Referring to FIG. 11, the pouch cover wing 1202 may be formed by bifurcating from an end of the pouch cover base 1201. For example, the pouch cover wing 1202 may include a first pouch cover wing 12021 and a second pouch cover wing 12022.

The first pouch cover wing 12021 and the second pouch cover wing 12022 may be bifurcated and extended from the end of the pouch cover base 1201. For example, the first pouch cover wing 12021 may be bent and extended from the end of the pouch cover base 1201 toward the first cell body lateral face 1131. For example, the second pouch cover wing 12022 may be bent and extended from the end of the pouch cover base 1201 toward the second cell body lateral face 1132. The pouch cover wing 1202 may form an upper surface of the battery cell 1000.

For example, the first pouch cover wing 12021 may extend forward from the upper end of the pouch cover base 1201. For example, the second pouch cover wing 12022 may extend rearward from the upper end of the pouch cover base 1201. The first pouch cover wing 12021 may be referred to as a “front cover wing”. The second pouch cover wing 12022 may be referred to as a “rear cover wing”.

The front pouch cover 1210 may extend downward from a front end of the front pouch cover wing 12021. The rear pouch cover 1230 may extend downward from a rear end of the rear pouch cover wing 12022.

A method of forming the pouch cover wing 1202 and the pouch cover base 1201 is described. Each of two parts of the pouch sheet 1020 (see FIGS. 4 and 5) may extend from the cell body upper surface 1120 (see FIG. 6). In the two parts of the pouch sheet 1020 (see FIGS. 4 and 5) each extending from the cell body upper surface 1120 (see FIG. 6), portions adjacent to the cell body upper surface 1120 (see FIG. 6) may be coupled to each other to form the pouch cover base 1201.

The pouch sheet inner surface 1020b (see FIG. 5) of the pouch cover wing 1202 may face upward. In other words, the pouch sheet inner surface 1020b (see FIG. 5) of the pouch cover wing 1202 may form the upper surface of the battery cell 1000.

The first pouch cover 1210 may extend from an end of the first pouch cover wing 12021 toward the bottom plate 211 (see FIG. 2). The third pouch cover 1230 may extend from an end of the second pouch cover wing 12021 toward the bottom plate 211 (see FIG. 2).

The heat transfer unit 1300 may be disposed between the first pouch cover 1210 and the cell body 1100. The heat transfer unit 1300 may be disposed between the third pouch cover 1230 and the cell body 1100. The heat transfer unit 1300 may be applied to at least one of the first cell body lateral face 1131 and the second cell body lateral face 1132.

The heat transfer unit 1300 may be connected to the bottom plate 211 (see FIG. 2). The heat transfer unit 1300 may transfer heat to the bottom plate 211 (see FIG. 2). For example, at least a portion of heat generated in the cell body lateral face 1130 may be transferred to the bottom plate 211 (see FIG. 2) through the heat transfer unit 1300.

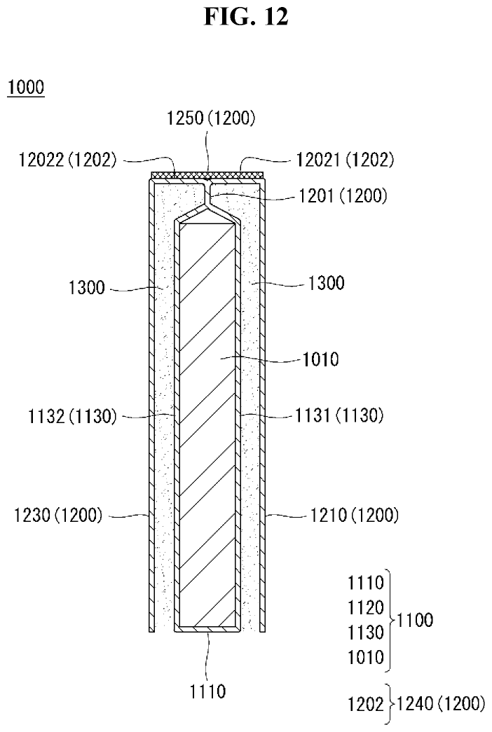

FIG. 12 illustrates that a pouch reinforcement part is coupled to a pouch cover wing of FIG. 11.

Referring to FIG. 12, the pouch cover 1200 may include a pouch reinforcement part 1250. The pouch reinforcement part 1250 may provide rigidity to the pouch cover wing 1202.

The pouch reinforcement part 1250 may be formed of the pouch sheet 1020 (see FIGS. 4 and 5). The pouch reinforcement part 1250 may form at least a portion of the upper surface of the battery cell 1000.

The pouch reinforcement 1250 may be coupled to the pouch cover wing 1202. The pouch reinforcement part 1250 may be coupled to at least a portion of the pouch cover wing 1202. For example, the pouch reinforcement part 1250 may face and cover a boundary between the first pouch cover wing 12021 and the second pouch cover wing 12022.

For example, the first pouch sheet layer 1021 (see FIG. 5) of the pouch reinforcement part 1250 may be coupled to the first pouch sheet layer 1021 (see FIG. 5) of the pouch cover wing 1202.

For another example, the pouch reinforcement part 1250 may be formed of a material with rigidity. For example, the pouch reinforcement part 1250 may be formed of a material including a heat conductive material. For example, the pouch reinforcement part 1250 may be formed of a material including metal. The pouch reinforcement part 1250 may receive and radiate heat from the pouch cover wing 1202.

Referring to FIGS. 11 and 12, the pouch cover base 1201 may be formed by coupling the overlapped pouch sheets 1020 (see FIGS. 4 and 5) to each other, but the pouch cover wing 1202 and the side pouch covers 1210 and 1230 may be formed using a single pouch sheet 1020 (see FIGS. 4 and 5).

For example, the first pouch sheet layer 1021 (see FIG. 5) of the pouch cover wing 1202 may form an upper surface of the pouch cover wing 1202. The third pouch sheet layer 1023 (see FIG. 5) of the pouch cover wing 1202 may face an upper surface of the cell body 1100 or face the heat transfer unit 1300.

For example, the first pouch sheet layers 1021 (see FIG. 5) of the side pouch covers 1210 and 1230 and the third pouch sheet layers 1023 (see FIG. 5) of the side pouch covers 1210 and 1230 may face the lateral face of the cell body 1100 or face the heat transfer unit 1300. The side pouch covers 1210 and 1230 of the adjacent battery cells 1000 may face and

contact each other. In this case, the pouch covers 1210 and 1230 facing each other of the adjacent battery cells 1000 may be coupled to each other.

Referring to FIGS. 3 to 13, the plurality of battery cells 110 constituting the battery cell assembly 100 may include various types of battery cells 110. For example, a “first type battery cell” may be the battery cell 1000 illustrated in FIG. 6. For example, a “second type battery cell” may be the battery cell 1000 illustrated in at least one of FIGS. 7 to 12.

The plurality of battery cells 110 constituting the battery cell assembly 100 may include a plurality of first type battery cells 1000 and a plurality of second type battery cells 1000. For example, the plurality of first type battery cells 1000 and the plurality of second type battery cells 1000 may be alternately arranged while being arranged forward and backward.

Some embodiments or other embodiments of the present disclosure described above are not mutually exclusive or distinct from each other. Configurations or functions of some embodiments or other embodiments of the present disclosure described above can be used together or combined with each other.

It is apparent to those skilled in the art that the present disclosure can be embodied in other specific forms without departing from the spirit and essential features of the present disclosure. Accordingly, the above detailed description should not be construed as limiting in all aspects and should be considered as illustrative. The scope of the present disclosure should be determined by rational interpretation of the appended claims, and all modifications within an equivalent scope of the present disclosure are included in the scope of the present disclosure.

What is claimed is:

1. A battery cell comprising:
a cell body including an electrode assembly and a pouch sheet wrapping the electrode assembly, the cell body extending from a lower end and leading to an upper end, the pouch sheet being overlapped and contacted at the upper end;
a pouch cover formed of the pouch sheet, the pouch cover extending from the upper end of the cell body and facing a lateral face of the cell body; and
a heat transfer unit disposed between the cell body and the pouch cover.

2. The battery cell of claim 1, wherein the pouch cover includes a first pouch cover that extends downward from the upper end of the cell body and faces a first lateral face among the lateral face of the cell body.

3. The battery cell of claim 2, wherein the heat transfer unit contacts the first lateral face of the cell body and is connected to the lower end of the cell body.

4. The battery cell of claim 2, wherein the pouch cover includes a second pouch cover that extends from a lower end of the first pouch cover and is positioned below the cell body.

5. The battery cell of claim 4, wherein the pouch cover includes a third pouch cover that extends upward from the second pouch cover and faces a second lateral face among the lateral face of the cell body, and
wherein the second lateral face is positioned opposite the first lateral face.

6. The battery cell of claim 1, wherein the pouch cover includes a pouch cover wing, and
wherein the pouch cover wing includes a first pouch cover wing and a second pouch cover wing formed by bifurcating the overlapped pouch sheet in opposite directions at the upper end of the cell body.

7. The battery cell of claim 6, wherein the pouch cover includes a pouch reinforcement part coupled to an upper surface of the pouch cover wing.

8. The battery cell of claim 6, wherein the pouch cover includes:
a first side pouch cover bent and extended downward from the first pouch cover wing; and
a second side pouch cover bent and extended downward from the second pouch cover wing.

9. The battery cell of claim 1, wherein the heat transfer unit includes a cooling member that is applied to or contacts the lateral face of the cell body.

10. The battery cell of claim 9, wherein the heat transfer unit includes a flame blocking member formed of a material including at least one of an ethylene copolymer, aluminum hydroxide, or calcium carbonate, and
wherein the flame blocking member is applied to or contacts the cooling member.

11. A battery module comprising:
a battery cell assembly including a plurality of battery cells stacked forward and backward; and
a bottom plate positioned below the battery cell assembly and contacting the battery cell assembly,
wherein each of the plurality of battery cells includes:
a cell body including an electrode assembly and a pouch sheet wrapping the electrode assembly, the cell body extending from a lower end and leading to an upper end, the pouch sheet being overlapped and contacted at the upper end;
a pouch cover formed of the pouch sheet, the pouch cover extending from the upper end of the cell body and facing a lateral face of the cell body; and
a heat transfer unit disposed between the cell body and the pouch cover.

12. The battery module of claim 11, wherein the pouch cover includes a front pouch cover that extends downward from the upper end of the cell body and faces a front face among the lateral face of the cell body.

13. The battery module of claim 12, wherein the heat transfer unit contacts the front face of the cell body and is connected to the bottom plate.

14. The battery module of claim 12, wherein the pouch cover includes a lower pouch cover that extends from a lower end of the front pouch cover and is positioned below the cell body.

15. The battery module of claim 14, wherein the pouch cover includes a rear pouch cover that extends upward from the lower pouch cover and faces a rear face among the lateral face of the cell body.

16. The battery module of claim 11, wherein the pouch cover includes a pouch cover wing, and
wherein the pouch cover wing includes a first pouch cover wing and a second pouch cover wing formed by bifurcating the overlapped pouch sheet in opposite directions at the upper end of the cell body.

17. The battery module of claim 16, wherein the pouch cover includes a pouch reinforcement part coupled to an upper surface of the pouch cover wing.

18. The battery module of claim 16, wherein the pouch cover includes:
a first side pouch cover bent and extended downward from the first pouch cover wing; and
a second side pouch cover bent and extended downward from the second pouch cover wing.

19. The battery module of claim 11, wherein the heat transfer unit includes a cooling member that is applied to or contacts the lateral face of the cell body.

20. The battery module of claim 19, wherein the heat transfer unit includes a flame blocking member formed of a material including at least one of an ethylene copolymer, aluminum hydroxide, or calcium carbonate, and
wherein the flame blocking member is applied to or contacts the cooling member.
